(19) United States
(12) Patent Application Publication
(10) Pub. No.: US 2011/0213825 A1
(43) Pub. Date: Sep. 1, 2011

(54) DYNAMICALLY CONFIGURABLE CLUSTERS OF APPARATUSES

(75) Inventor: Michael Patrick Chrabaszcz, Milpitas, CA (US)

(73) Assignee: Rovi Technologies Corporation, Santa Clara, CA (US)

(21) Appl. No.: 12/713,596

(22) Filed: Feb. 26, 2010

(51) Int. Cl. G06F 15/16; G06F 15/173

(52) U.S. Cl. 709/203; 709/226

(57) ABSTRACT

A dynamically configurable cluster of apparatuses and methods and systems for dynamically configuring the apparatuses are disclosed. At a server computer, a list of identified resources available to the clustered apparatuses may be received from an apparatus of the cluster. The server computer may provide to the apparatus a list of functionalities including functionalities performable by one or more of the clustered apparatuses, based on the list of identified resources. A selection from the list of functionalities may be received from the apparatus. The server computer may provide one or more of the clustered apparatuses with additional resources, based on the selection. Additional systems and methods are disclosed.

### CROSS-REFERENCE TO RELATED APPLICATIONS

The present application is related to the following patent applications each assigned to a common assignee:

United States Patent Application [2147.026US1, CP0007] entitled, “DYNAMICALLY CONFIGURABLE CHAMELEON DEVICE,” which is hereby incorporated by reference.

U.S. patent application Ser. No. 12/622,766, filed on Nov. 20, 2009 and entitled, “DATA DELIVERY FOR A CONTENT SYSTEM,” which is hereby incorporated by reference.

### BACKGROUND

As the market for consumer electronics (CE) expands, more and more sophisticated CE devices become available. Today's CE device manufacturers are facing demands for more advanced features which can only be satisfied with high technology solutions. The use of processing power in many CE devices facilitates providing more technically advanced features in more compact and less expensive CE devices, such as various hand-held devices.

Also, network connectivity is becoming a new trend in more CE devices. For example, new models of television sets manufactured by various vendors are equipped with Internet capabilities for content delivery without the need for a personal computer (PC). Such Internet connectivity features may drastically improve the functionality of CE devices that utilize this feature.

### BRIEF DESCRIPTION OF THE DRAWINGS

Some embodiments of the disclosed technology are illustrated by way of example and not limitation in the figures of the accompanying drawings in which:

FIG. 1 is a diagram illustrating an example system for dynamically configuring an apparatus, according to various embodiments of the invention;

FIG. 2 is a high-level diagram illustrating an example dynamically configurable apparatus, according to various embodiments of the invention;

FIG. 3 is a diagram illustrating an example dynamically configurable apparatus, according to various embodiments of the invention;

FIG. 4 is a block diagram illustrating example modules of a dynamically configurable apparatus, according to various embodiments of the invention;

FIG. 5 is a flow diagram illustrating an example method of dynamically configuring an apparatus, according to various embodiments of the invention;

FIG. 6 is a block diagram illustrating an example architecture of a dynamically configurable CE device, according to various embodiments of the invention;

FIG. 7 is a diagram illustrating an example system for dynamically configuring a cluster of apparatuses, according to various embodiments of the invention;

FIG. 8 is a block diagram illustrating example modules of a server computer providing service to a dynamically configurable cluster of apparatuses, according to various embodiments of the invention;

FIG. 9 is a flow diagram illustrating an example method of providing service to a dynamically configurable cluster of apparatuses, according to various embodiments of the invention; and

FIG. 10 is a diagram illustrating a diagrammatic representation of a machine in the example form of a computer system.

### DETAILED DESCRIPTION

An example dynamically configurable cluster of apparatuses and methods for dynamically configuring the apparatuses are described. In the following description, for the purpose of explanation, numerous examples having example-specific details are set forth to provide an understanding of example embodiments. It will be evident, however, to one of ordinary skill in the art that the present examples may be practiced without these example-specific details, and/or with different combinations of the details than are given here.

Some example embodiments including a dynamically configurable cluster of apparatuses and methods and systems for dynamically configuring the apparatuses are provided. At a server computer, a list of identified resources available to the clustered apparatuses may be received from an apparatus of the cluster, also called a configurable chameleon device. The server computer may provide to the apparatus a list of functionalities, including functionalities performable by one or more of the clustered apparatuses, based on the list of identified resources. A selection from the list of functionalities may be received from the apparatus. The server computer may provide one or more of the clustered apparatuses with additional resources, based on the selection.

Example methods may include dynamically identifying the list of resources initially such as, for example, after the apparatus is turned on for the first time, and/or upon detecting a change in the resources available to the apparatus such as, for example, when an external resource such as a universal serial bus (USB) is coupled to the apparatus. The resources initially available to the apparatus may include sufficient capabilities to perform an initial bringing up of an operating system and providing a network connection to a server computer. In implementations, the network includes the Internet or another network. Generally, the apparatus at this point is blank in terms of any functionality or feature that is utilized by a user. However, the apparatus is able to redefine itself, or be defined, by configuring its resources to perform various functionalities as discussed in more detail below.

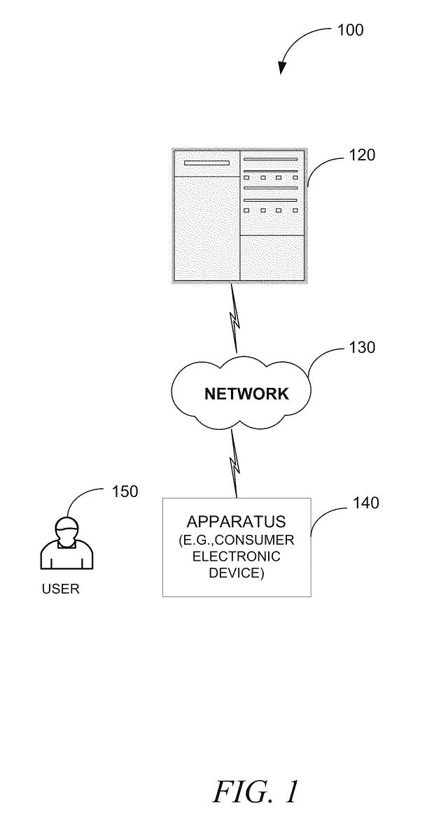

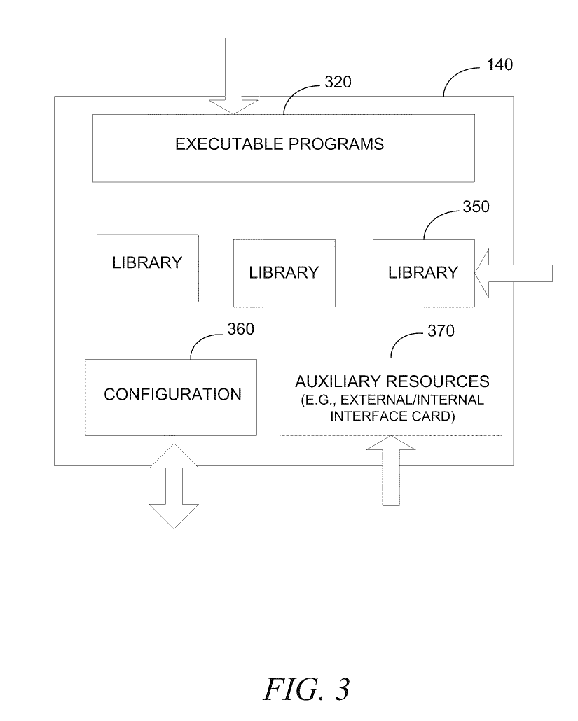

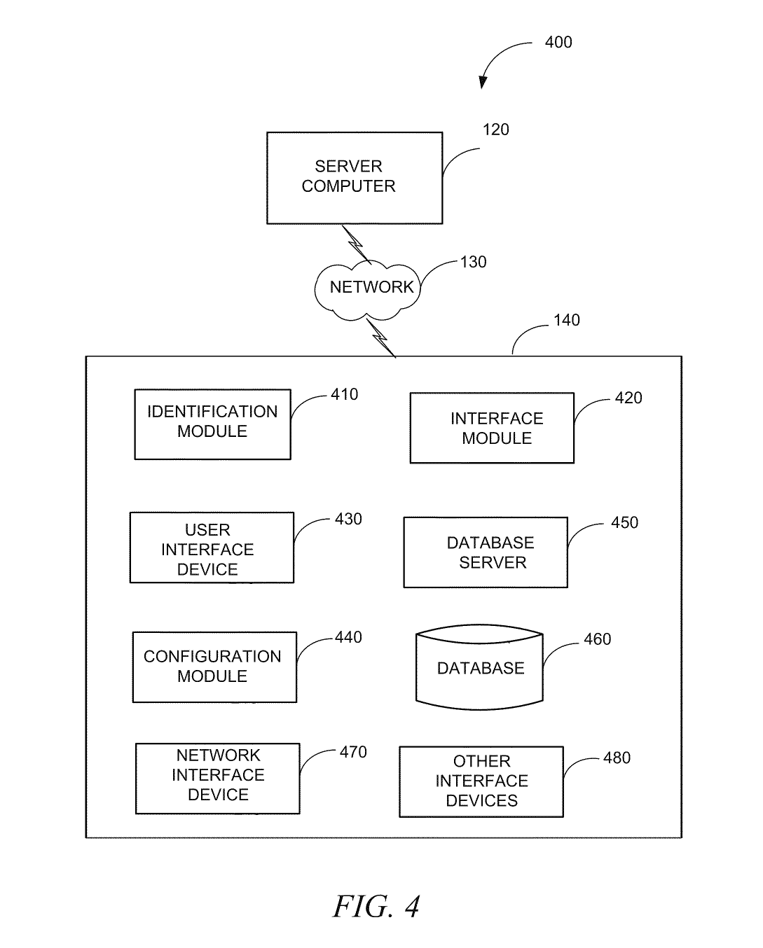

FIG. 1 is a diagram illustrating an example system 100 for dynamically configuring an apparatus 140, according to various embodiments of the invention. The system 100 may include the apparatus 140, a network 130 and a server computer (hereinafter, also called “server”) 120. The apparatus 140 may initially identify a list of resources that may be available to the apparatus 140 as shown, for example, in FIGS. 3 and 4. The apparatus 140 may identify the list of resources dynamically such as, for example, upon detection of a change in the resources. A change in resources may occur, for instance, when the apparatus 140 detects that a device, such as a USB type device, is coupled to or decoupled from the apparatus 140 or replaced with another device, for instance a higher capacity USB type device.

Following the identification of resources, the apparatus 140 may communicate with the server 120. Generally, the server 120 is maintained and/or operated by a service provider such as, for example, a service provider implemented by Rovi™ Corporation of Santa Clara, Calif. After communicating with the server 120, the apparatus 140 may identify itself, for instance, via a registration number, etc., to the server 120 and after some authentication processes, provide the server 120 with a list of identified resources that are available to the apparatus 140. The resources may include hardware and/or software resources.

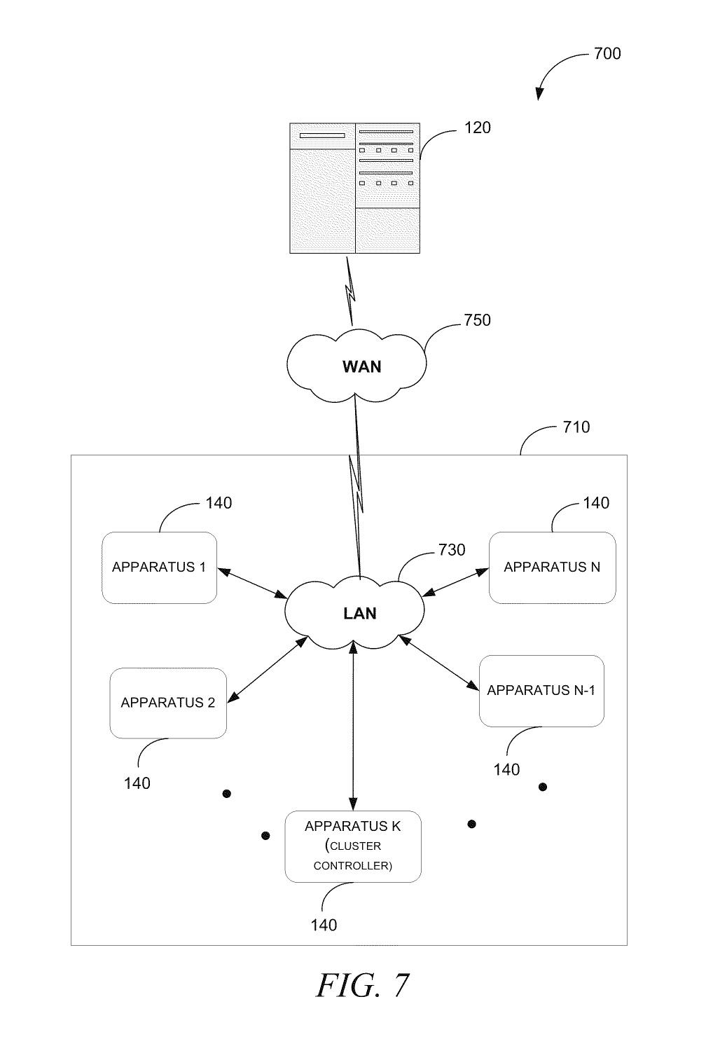

The server 120 may analyze the list of resources received from the apparatus 120 and, based on the potential capabilities of the resources, provide a list of functionalities to the apparatus 140. In an example embodiment, the server 120 is able to detect the resources available to the apparatus 140 upon coupling of the apparatus 140 to the server 120. The list of resources received from the apparatus 120 may also be added to resources available to the cluster 710 of FIG. 7 and advertised to the apparatuses 140 of the cluster 710. The list of functionalities provided by the server 120 may be presented to a user 150 as configuration/feature options. The list of functionalities may include, for example, functionalities associated with consumer electronic devices such as a television, a digital versatile disk (DVD) player and/or recorder, a compact disk (CD) player and/or recorder, a personal video recorder (PVR), or functionalities of more sophisticated scientific and/or research instruments such as an oscilloscope or a pulse height analyzer (PHA) and so forth.

The user 150 may select one or more desired configuration and/or feature options. For example, the user 150 may want to use the apparatus 140 as a PVR. In this case, after acquiring the additional resources, the apparatus 140 may redefine itself by configuring its resources to perform as a PVR. The apparatus 140 may perform the functionality of a PVR and at the same time offer features such as, for example, a number and type of controls or displays, etc., that are selected by the user 150.

Some currently available consumer electronic devices may be able to download updated files from a server via the Internet and perform the functionalities that are predefined at time of manufacturing. The capabilities discussed above with respect to the apparatus 140 being able to dynamically redefine or configure itself to perform one or more desired functionalities and/or features selected by the user 150 may not be present in many existing devices or instruments. For example, as the hardware and software configuration of the apparatus 140 changes, such as, for example, by adding new hardware or downloading new features, the list of available features offered to the user 150 is dynamically adjusted. More details regarding various resources available to the apparatus 140 and additional resources provided by the server 120 are discussed below.

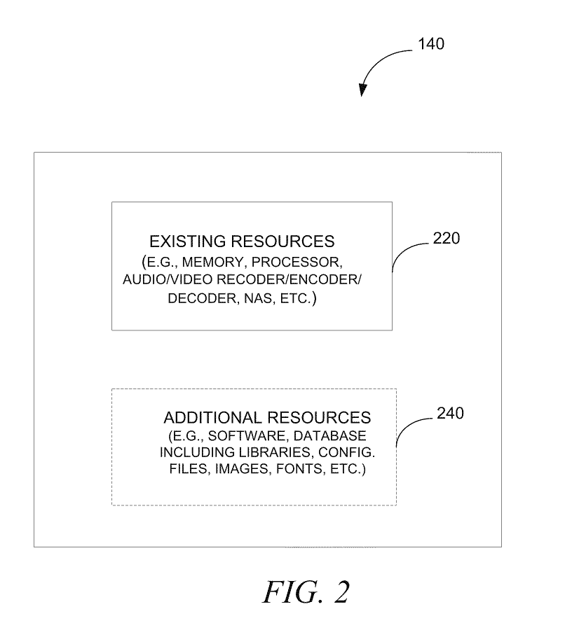

FIG. 2 is a high-level diagram illustrating an example dynamically configurable apparatus 140, according to various embodiments of the invention. The apparatus 140 may initially include resources 220. The existing resources 220 may, for example, include some processing power such as via one or more processors, or some storage capacity, for example, in the form of volatile memory, such as random access memory (RAM), non-volatile memory, such as read only memory (ROM), flash memory, and the like. The existing resources 220 may also include one or more interfaces such as audio and/or video inputs, outputs, USB interfaces, network and/or Ethernet interfaces, public switched telephone network (PSTN) jacks, high definition multimedia interfaces (HDMI), antennas, etc.

After reporting the existing resources 220 to the server 120 of FIG. 1, the apparatus 140 may receive additional resources 240 from the server 120 via the network 130. The additional resources 240 may include software applications and/or one or more databases. The databases may contain libraries, configuration files, images, fonts, and so forth. The software may include various applications and executable programs that are executable by the resources 220. In example embodiments, the applications and executable programs may also employ other components of the additional resources 240, including libraries and databases.

FIG. 3 is a diagram illustrating an example dynamically configurable apparatus 140, according to various embodiments of the invention. In the example embodiment shown in FIG. 3, only the dynamic components of the existing resources 220 of FIG. 2 that are available to the apparatus 140 are shown. For example, executable programs 320 may be modified by the server 120 of FIG. 1, or library 350 may be part of the additional resources provided by the server 120 to equip the apparatus 140 with certain functionalities. The configuration 360 may include configuration files that are provided or updated by the server 120. The configuration 360 may also save the current configuration of the apparatus 140 in certain configuration files.

The auxiliary resources 370 are coupled to the apparatus 140 to provide additional functionalities and/or features to the apparatus 140. In some cases, an auxiliary resource 370 is coupled to and internal within the apparatus 140. For example, the auxiliary resources 370 may include certain internal and/or external interface cards coupled to the apparatus 140. Technical specifications of the auxiliary resources 370 may be reported to the server 120. The server 120, based on the added capabilities of the auxiliary resources 370, provides the apparatus 140 with executable programs, such as drivers and/or libraries (such as dynamic link libraries (DLL)) to enable the apparatus 140 to perform new functionalities.

FIG. 4 is a block diagram illustrating example modules 400 of a dynamically configurable apparatus 140, according to various embodiments of the invention. The apparatus 140 may include an identification module 410, an interface module 420, a user interface device 430, a configuration module 440, a database server 450, a database 460, a network interface device 470 and other interface devices 480. The apparatus 140 may be coupled to the server 120 via the network 130.

The identification module 410 preferably identifies the list of existing resources 220 of FIG. 1 initially available to the apparatus 140. However, the identification module 410 may act dynamically; for example, when an external device such as an auxiliary resource 370 of FIG. 3, for example, is coupled to the apparatus 140, the identification module 410 may identify the external device and update the list of existing resources 220 of FIG. 2.

The identification module 410 is further preferably able to detect technical specifications of the existing resources 220 of FIG. 2 and provide information associated with or identifying the technical specifications to the configuration module 440, the database server 450, and/or the network interface device 470. The network interface device 470 may communicate the list of the existing resources 220 of FIG. 2 to the server 120 via the network 130. The network interface device 470 may also communicate a request for a list of functionalities to the server 120. The server 120 may analyze the list of resources 220, and based on the capabilities and capacities of the resources 220, prepare a list of functionalities that the apparatus 140 is able to perform. The list of functionalities is received by the network interface device 470 and passed to the database server 450 to be stored in database 460.

The interface module 420 may obtain the list of functionalities from the database 460 and provide an interface to the user interface device 430. The interface may include functionality and/or feature options for presentation to the user 150 of FIG. 1. The user interface device 430 may display the user interface to the user 150. The user 150 may select one or more of the displayed functionality and/or feature options. The selected functionality and/or feature options are communicated by the network interface device 470 to the server 120. The server 120 may provide the apparatus 140 with additional resources 240 of FIG. 2. Using the additional resources 240 and the existing resources 220, the apparatus 140 advantageously performs the functionalities and features desired by the user 150.

The other interface devices 480 may include audio and/or video inputs, outputs, USB interfaces, network interfaces, Ethernet interfaces, PSTN jacks, HDMI, antennas, wireless network interfaces, and so forth. Once identified to the server 120, each of the other interface devices 480 may become part of a solution to provide certain functionality to the apparatus 140.

Once the additional resources 240 of FIG. 2 are acquired by the apparatus 140, the configuration module 440 may configure the apparatus 140 to perform functionalities selected by the user 150 of FIG. 1. The configuration module 440 also preferably stores the current configuration of the apparatus 140 within the database 460. The current configuration may be a temporary configuration that the user 150 uses for a limited time, for example, over a weekend. After that time, the user may select or switch to a different functionality, as long as that functionality is provided by the server 120. Such temporal services may promote the ability of service providers to rent the functionalities, for example, to apparatuses 140 of the cluster 710 of FIG. 7.

Many CE devices use operations that may allow hackers to break into the device, identify executables and libraries, and reverse engineer the device. An example embodiment may protect the apparatus 140 from such hacking activities by using the database 460 to store configurations, executables and libraries. In another example embodiment, the database 460 may further protect the apparatus 140 by encrypting stored features. Some embodiments employ a structured query language (SQL) database.

Once the apparatus 140 is configured, the user 150 may add new hardware that implements, for example, one or more of the auxiliary resources 370 of FIG. 3. The user 150 may further upgrade functionalities that the apparatus 140 is capable of performing. For instance, the user 150 may download new functionalities and/or features from the server 120. In a particular case, the user 150 couples a USB device to the apparatus 140 that includes, for example, a digital television. Then, the user 150 advantageously configures the television as a PVR for use of the PVR functions by the user. The alternative configuration may occur at a remote location and/or for a limited time. For instance, the alternative configuration for the television and PVR combination device may be during a weekend so that the user 150 is enabled to rent software while visiting a beach vacation house or another temporary location. The configuration module 440 may automatically disable a functionality related to the resource associated with the external device, e.g., the USB device, after the external device is disconnected and/or removed from the apparatus 140.

In an example embodiment, the user 150 may desire to have a certain added functionality within the apparatus 140, but is not sure how the apparatus 140 is able to perform that functionality. The user 150 communicates the desired functionality request to the user interface device 430. The user interface device may pass the desired functionality request to the network interface device 470, which may in turn communicate the desired functionality request to the server 120.

The server 120 may analyze the desired functionality request and provide the network interface device 470 with a list of one or more external devices that is coupled to the apparatus 140 to perform the desired functionality. The user interface device 430 may receive the list of one or more external devices and communicate the list to the user 150. Once the one or more external devices are coupled to the apparatus 140, the configuration module 440 configures the apparatus 140 to perform the desired functionality.

In some embodiments, the server 120 communicates warnings to the user 150 with respect to possible performance issues when the apparatus 140 lacks sufficient capabilities or marginally meets the requirements to support a requested functionality. For example, the user 150 may request PVR functionality where the apparatus 140 has a flash memory and/or removable memory stick as the only available memory. The server 120 may warn the user 150 of potential poor user experience, based on historical data and/or customer feedback stored in a database.

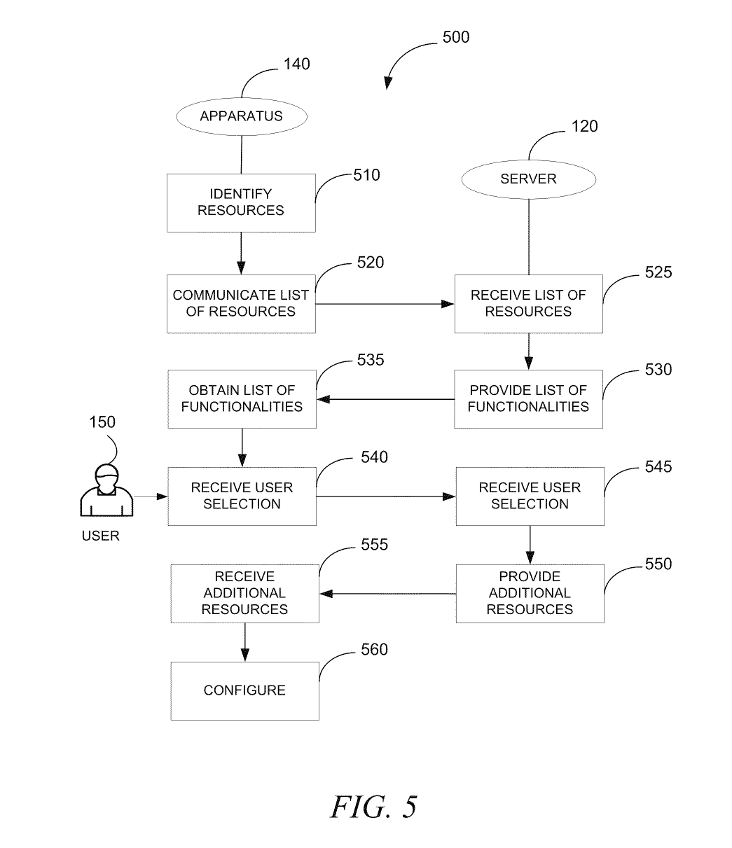

FIG. 5 is a flow diagram illustrating an example method 500 of dynamically configuring an apparatus 140, according to various embodiments of the invention. As shown in FIG. 5, the method 500 begins at operation 510, where the identification module 410 of FIG. 4 dynamically identifies a list of existing resources 220 of FIG. 2 available to the apparatus 140 of FIG. 1.

At operation 520, in response to the identification, the network interface device 470 may communicate the list of existing resources 220 to the server 120 over the network 130 of FIG. 1. At operation 525, the server 120 receives the list of existing resources 220 from the apparatus 140. The server 120 may analyze the list of existing resources 220 available to the apparatus 120 to prepare a list of functionalities based on the list of resources 220. At operation 530, the server 120 may provide the apparatus 140 with the list of functionalities.

In some embodiments, the server 120 generates a database to store the list of identified resources 220, the list of functionalities, and a current configuration of the apparatus 140. The server 120 may dynamically update the database. The server 120 may provide the apparatus 140 with promotional materials to present to the user 150. The promotional materials may be in the form of advertisements that promote various functionalities performable by the apparatus 140 to the user 150.

At operation 535, the network interface device 470 may receive the list of functionalities from the server 120 over the network 130. The network interface device 470 may pass the list of functionalities to the database server 450 of FIG. 4 to store in the database 460 of FIG. 4. The user interface module 420 of FIG. 4 may obtain the list of functionalities from the database 460 and prepare an interface showing the list of functionalities in a presentable format.

At operation 540, the user interface device 430 of FIG. 4 may display the interface to the user 150 and receive a selection made by the user 150 from the list of functionalities. The network interface device 470 may communicate the selection to the server 120 over the network 130. At operation 545, the server 120 may receive the selection from the network interface device 470. The server 120 may, at operation 550, provide additional resources 240 of FIG. 2 to the apparatus 140. The additional resources 240 may be provided based on the selected functionalities by the user 150.

At operation 555, the network interface device 470 may receive additional resources 240 and pass them to the database server 450 for storage in the database 460. The configuration module 440 of FIG. 4 may obtain a list of the additional resources from the database 460. At operation 560, the configuration module 440 may configure the apparatus 140 to perform the selected functionalities by using the existing resources 220 available to the apparatus 140 and the additional resources 240 provided by the server 120. The configuration module 440 may also save the current configuration of the apparatus 140 within the database 460.

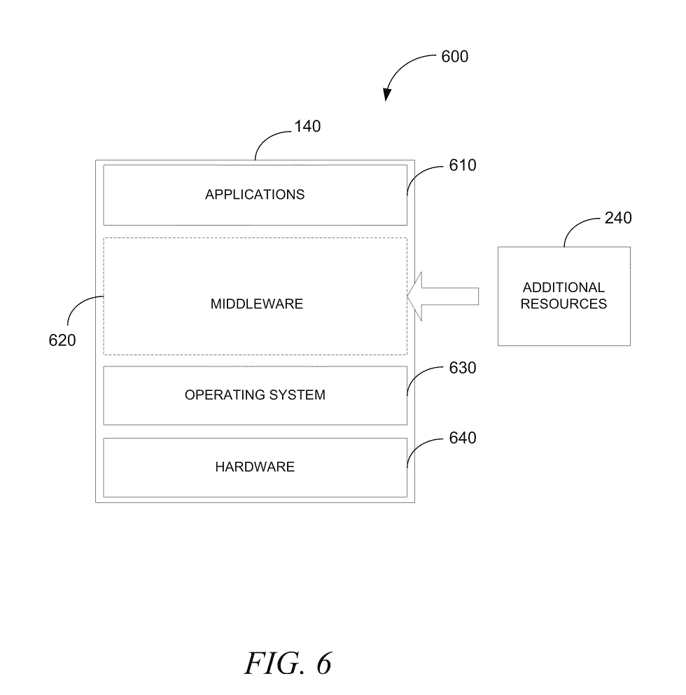

FIG. 6 is a block diagram illustrating an example architecture 600 of a dynamically configurable CE device, according to various embodiments of the invention. The CE device may be an embodiment of the apparatus 140, as shown in FIG. 6. In the architecture 600, the hardware block 640 may include various hardware, for example, memory, processors, input and/or output devices, interface devices, amplifiers, tuners, and the like. In example embodiments, the hardware block 640 may include entire components and/or portions of the components of the apparatus 700, as shown in FIG. 7. FIG. 7 is further discussed below. The hardware block 640 may be modified by a user via coupling external devices, such as various electronic boards, USB devices, network interface devices, and the like.

The operating system 630 may include Linux or various other operating systems. The apparatus 140 may be able to bring up this operating system upon powering up at its initial state to enable the apparatus 140 to communicate with the server 120 and the network 130 of FIG. 1. In example embodiments, the middleware 620 may be modified to include the additional resources 240. The middleware 620 may comprise a program that coordinates the activities of one or more hardware and/or software components to perform one or more functionalities. For example, in a PVR, the middleware 620 may coordinate activities of one or more encoders, audio/video play backs, graphic outputs, video outputs, storage device adaptors, and the like to perform functionalities of the PVR.

The additional resources 240 may include one or more software and/or databases. The databases may contain libraries, configuration files, images and fonts, and so forth. The software may include various applications and executable programs that are executable by the hardware block 640. In example embodiments, the applications and executable programs included in the additional resources 240 also employ other components of the additional resources 240, including libraries and databases. The applications and executable programs included in the additional resources 240 may also use contents of applications block 610. The applications block 610 may include software which initially existed in the original configuration of the apparatus 140.

FIG. 7 is a diagram illustrating an example system 700 for dynamically configuring a cluster 710 of apparatuses 140, according to various embodiments of the invention. In some embodiments, the server 120 may provide service to an environment of dynamically configurable apparatuses 140. The environment may include multiple interconnected apparatuses 140 that form the cluster 710. The cluster 710 may comprise a local cluster including, for instance, a home cluster, a car cluster, a vacation home cluster, and the like. The local clusters may be associated with a user 150 of FIG. 1 and form “associated clusters.” The local clusters may, for example, comprise N apparatuses 140 (e.g., APPARATUS_1, APPARATUS_2, through APPARATUS_N). The apparatuses 140 of different local clusters may or may not be similar. The home cluster may comprise a television, an amplifier, a video cassette recorder (VCR), a PVR, a PC, a network access device, a digital picture frame, a digital media adaptor (DMA), and so forth. The car cluster may, for instance, comprise an AM/FM radio, a DVD player/recorder, a cell phone, a global positioning service (GPS) device, and the like.

The apparatuses 140 of the cluster 710 may form a local area network (LAN) 730 such as, for example a home or office network. The apparatuses may communicate with the server 120 via a wide area network (WAN) 750, such as the Internet. The apparatuses 140 may use the LAN 730 to communicate with the WAN 750 and/or may have independent communication means such as satellite communication means. In embodiments, the server 120 provides resources such as computer programs to reconfigure each of the apparatuses 140 to enable them to perform specialized functionalities, as described in detail below. The computer programs may be received such as, for example, downloaded by the apparatuses 140.

In the cluster 710, a first apparatus 140 such as, for example, APPARATUS_K, initiates a communication with the server 120 for the first time and may be assigned a cluster controller role. When acting as a cluster controller, the apparatus 140 may perform a number of tasks. For example, the cluster controller (that is, the apparatus 140, which is assigned the cluster controller role) may act as an intermediary between other apparatuses 140 of the cluster 710 and the server 120. In an embodiment, the cluster controller may act as an agent of the server 120, for instance, in receiving information from other apparatuses 140 of the cluster 710 or delivering information and/or resources to these apparatuses.

When turned on for the first time, the apparatuses 140, including the cluster controller, identify themselves to the server 120, and receive a cluster program. The cluster program assists the apparatuses 140 in identifying the other apparatuses 140 in the cluster 710, including the cluster controller. The cluster program may also be used to configure the apparatuses 140 to share resources among themselves and/or with other local clusters of the associated clusters, for instance, through cluster controllers of the associate clusters.

For example, the user 150 of FIG. 1 may want to record a television show and the television that is part of the cluster 710 does not have sufficient capability to record the television show. In this case, the cluster controller may use a PVR application available from the server 120 to combine the available resources in other apparatuses 140 of the cluster 710 in order to perform PVR functionality. The available resources may, for instance, include audio and video encoders and storage capacity. The storage capacity may be available on a hard drive of a PC, an external hard drive, a flash memory and the like. In some embodiments, the apparatuses 140 of the cluster 710 and/or the associated clusters may collaborate to implement a requested functionality. For instance, the apparatuses 140 of the cluster 710 and/or the associated clusters may search for content among themselves and transfer content from one apparatus 140 to one or more apparatuses 140 of the cluster 710 and/or the associated clusters.

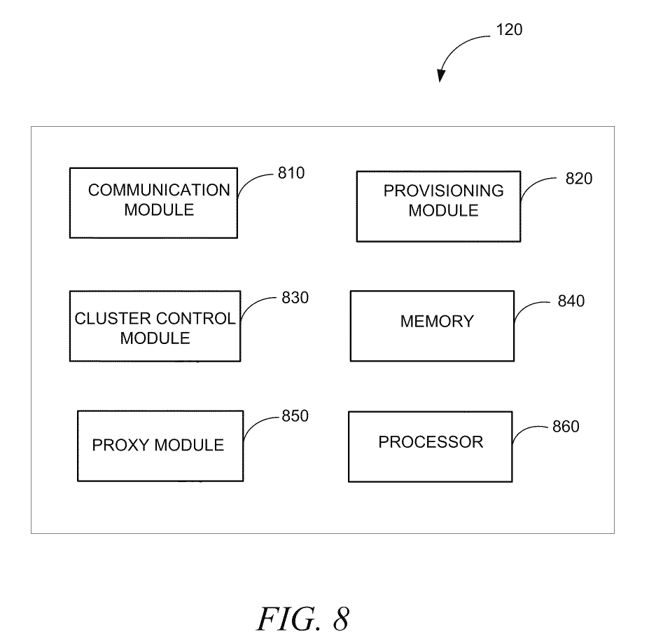

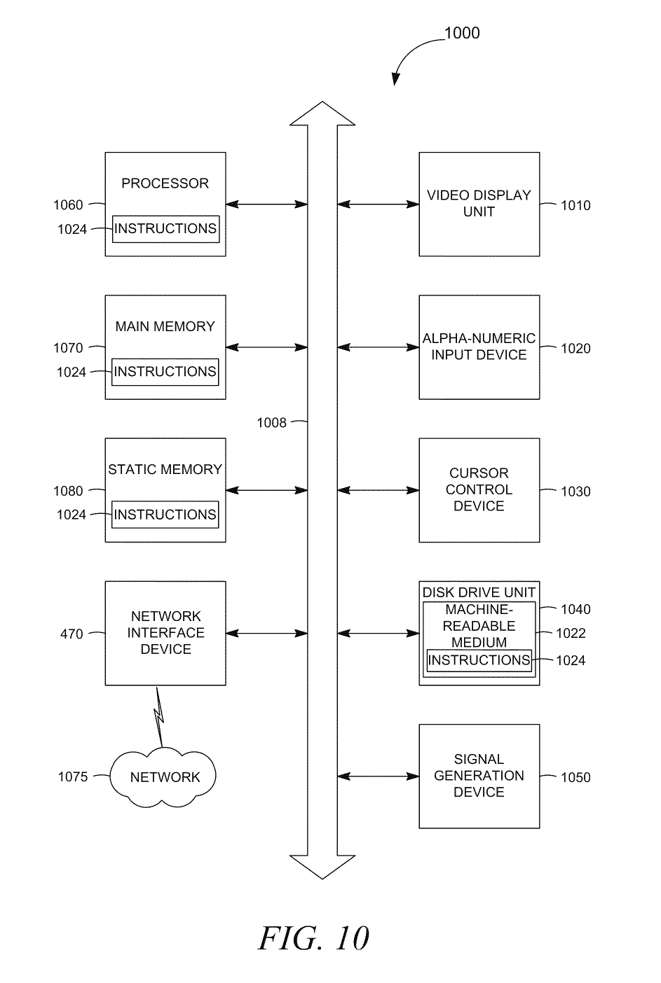

FIG. 8 is a block diagram illustrating example modules of the server 120 providing service to a dynamically configurable cluster 710 of apparatuses 140 of FIG. 7, according to various embodiments of the invention. The server computer 120 may comprise a communication module 810, a provisioning module 820, a cluster control module 830, a memory 840, a proxy module 850, and a processor 860. The provisional module 820, the cluster control module 830, and the proxy module 850 may be implemented in hardware and/or software. The software may be implemented by the processor 860 or the processor 1060 shown in FIG. 10.

The communication module 810 may be implemented in hardware and, for example, operate as the network interface device 470 shown in FIGS. 4 and 10. The communication module 810 may receive from one of the apparatuses 140 of the cluster 710, via a network such as WAN 750 of FIG. 7, a list of identified resources, such as existing resources 220 of FIG. 2 available to one or more of the apparatuses 140. The existing resources 220 may include software and/or hardware such as, for instance, processor, storage device, one or more interfaces, antennas, and the like. The resources 220 may also include some resources associated with one or more external devices that may be coupled to the one or more apparatuses 140.

In an embodiment, the apparatuses 140 of the cluster 710 may communicate lists of their existing resources 220 to the cluster controller of the cluster 710. The server 120 may then receive the list of existing resources 220 from the cluster controller of the cluster 710. The provisional module 820 may provide the apparatuses 140 of the cluster 710 with a list of functionalities, based on the list of identified existing resources 220. The functionalities may be performable by one or more apparatuses 140 of the cluster 710 by using the existing resources 220. For example, the list of functionalities may include functionalities associated with CE devices such as a television, a DVD player and/or recorder, a CD player and/or recorder, a PVR, or functionalities of more sophisticated scientific and/or research instruments such as an oscilloscope or a PHA and so forth.

The communication module 810 may receive from the apparatuses 140 of the cluster 710 a selection from the list of functionalities. For example, the user 150 of FIG. 1 may want to use one of the apparatuses 140 as a PVR. In this case, after receiving the additional resources, the apparatus 140 may redefine itself by configuring its resources to perform as a PVR. The apparatus 140 may perform the functionality of a PVR and at the same time offer features such as, for example, a number and type of controls or displays, etc., that are selected by the user 150.

The provisioning module 820 may provide one or more of the apparatuses 140 of the cluster 710 with additional resources 240 based on the selection. The additional resources 240 may include software applications and/or one or more server databases stored in the memory 840. The server databases may contain libraries, configuration files, images, fonts, and so forth. The software may include various applications and executable programs that are executable by the resources 220 of FIG. 2. For example, the software may include a cluster program as discussed below. The server databases may be updated by the processor 860, as supplements to additional resources 240 become available to the server computer 120.

In some embodiments, the provisioning module 820 may facilitate formation of the cluster 710 and/or associated clusters comprising, for instance, a local cluster such as a home cluster, a car cluster, a vacation home cluster, and the like. The cluster program may assist each apparatus 140 in detecting other apparatuses 140 in the cluster 710, including the cluster controller. The cluster program may also be used to configure the apparatuses 140 to share resources among themselves and/or with other local clusters of the associated clusters, for instance, through cluster controllers of the associate clusters. The provisioning module 820 may facilitate two or more local clusters sharing resources, for instance existing resources 220 and additional resources 240 both of FIG. 2 or content, such as, electronic publications, images, media content including various forms of audio/video content, and so forth.

In some embodiments, the cluster control module 830 of FIG. 8 may assign a cluster controller role to one of the apparatuses 140 of the cluster 710 of FIG. 7. The cluster controller may perform certain tasks as described above with respect to FIG. 7. When the cluster controller is not available, the cluster control module 830 may reassign the cluster controller role to another apparatus 140 of the cluster 710. The communication module 810 may receive a request from the other apparatus 140 to act as the cluster controller, when the other apparatus 140 fails to detect a cluster controller.

Preferably, the cluster control module 830 periodically, for instance once a day, monitors the qualifications of apparatuses 140 to find out which apparatus 140 is a better candidate for the cluster controller role. The cluster control module 830 may then assign the cluster controller role to another apparatus 140, when that apparatus 140 is more qualified than a current cluster controller. The more qualified apparatus may, for example, have a longer uptime, more resources such as processing power or storage capacity, or better performance, for instance higher speed, shorter response time, higher amplification, more fidelity, higher resolution, and the like. Further, the cluster controller may identify one of the apparatuses 140 as a standby cluster controller.

The standby cluster controller may assume the responsibilities of an active cluster controller in case the active cluster controller is down or otherwise fails to perform one or more of the cluster controller's tasks. The active cluster controller and the standby cluster controller may receive control resources such as programs and databases from the provisioning module 820. The control resources may enable the active cluster controller and the standby cluster controller to perform cluster controller tasks as outlined with respect to FIG. 7. The control resources may also facilitate the cluster controller in identifying existing resources 220 and additional resources 240 as well as functionalities available to each of the apparatuses 140 of the cluster 710 both of FIG. 7.

In some embodiments, one of the apparatuses 140 of the cluster 710 may act as a proxy for the server 120 of FIG. 7. The proxy module 850 may permit that apparatus 140 to act as a proxy for the server 120. Each of the apparatuses 140 may volunteer for the proxy role by sending a message to the server 120. The proxy module 850 may facilitate for the apparatus 140 that acts as a proxy for the server 120 to perform one or more of the functionalities associated with the server 120. The proxy module 850 may request from the provisioning module 820 to provide the volunteered apparatus 140, such as a PC, with resources such as programs, libraries, databases, and so forth to enable the volunteered apparatus 140 to perform as a proxy for the server 120.

In an embodiment, the communication module 810 may receive a selected functionality for one or more of the apparatuses 140 of the cluster 710 both of FIG. 7 from the user. In this case, the provisioning module 820 provides a list of a number of external devices to be coupled to each of the one or more apparatuses 140 to enable them to perform the selected functionality. For example, the list may include external memory such as flash memory, a display, a PC, and the like. The provisioning module 820 may, for instance, recommend that the apparatus 140 be coupled to another apparatus 140 of the cluster 170 so that it can perform the selected functionality.

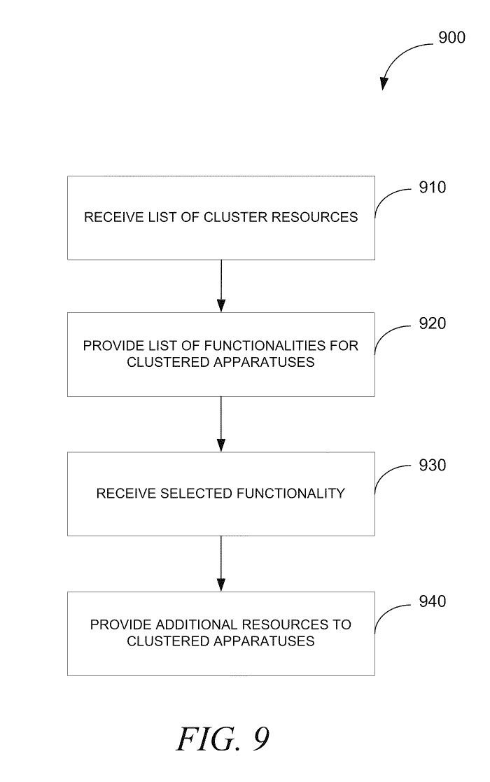

FIG. 9 is a flow diagram illustrating an example method 900 of providing service to a dynamically configurable cluster of apparatuses, according to various embodiments of the invention. As shown in FIG. 9, the method 900 begins at operation 910, where the communication module 810 of FIG. 8 may receive from one of the apparatuses 140 of the cluster 710 of FIG. 7, via the WAN 750 (also of FIG. 7), a list of identified resources, such as existing resources 220 of FIG. 2 available to the apparatuses 140 of the cluster 710. In an embodiment, the server 120 of FIG. 7 is able to detect the resources available to the apparatus 140 upon coupling the apparatus 140 to the server 120.

At operation 920, the provisioning module 820 of FIG. 8 may provide one of the apparatuses 140 of the cluster 710 with a list of functionalities. The functionalities may be performable by one or more of the apparatuses 140 of the cluster 710, by using the identified resources. The list of functionalities may include, for example, functionalities associated with consumer electronic devices such as a television, a DVD player and/or recorder, a CD player and/or recorder, a PVR, or functionalities of more sophisticated scientific and/or research instruments such as an oscilloscope or a pulse height analyzer, and so forth.

At operation 930, the communication module 810 of FIG. 8 may receive from the user 150 of FIG. 1 a selection from the list of functionalities. At operation 940, the provisioning module 820 may provide the one or more apparatuses 140 of the cluster 710 with additional resources 240 of FIG. 2, based on the selection. For instance, the user 150 may want to use the apparatus 140 as a PVR. In this case, after receiving the additional resources 240, the apparatus 140 may redefine itself by configuring its resources to perform as a PVR. The apparatus 140 may perform the functionality of a PVR and at the same time offer features such as, for example, a number and type of controls or displays that are selected by the user 150 of FIG. 1.

FIG. 10 is a diagram illustrating a diagrammatic representation of a machine 1000 in the example form of a computer system, within which a set of instructions for causing the machine 1000 to perform one or more of the methodologies discussed herein may be executed. In alternative embodiments, the machine 1000 may operate as a standalone device or be coupled and/or networked to other apparatus. In a networked deployment, the machine 1000 may operate in the capacity of a server such as the server 120 of FIGS. 1 and 7 or a client apparatus such as the apparatuses 140 of FIG. 7, in a server-client network environment, or as a peer apparatus in a peer-to-peer and/or distributed network environment.

The machine 1000 may be a server computer, a client computer, a PC, a tablet PC, a set-top box (STB), a personal digital assistant (PDA), a cellular telephone, an Internet or Web appliance, a network router, switch or bridge, or any apparatus capable of executing a set of instructions, sequential or otherwise, that specify actions to be taken by that apparatus. Further, while only a single apparatus is illustrated, the term “apparatus” shall also be taken to include any collection of apparatuses that individually or jointly execute a set, or multiple sets, of instructions to perform any one or more of the methodologies discussed herein.

The example machine 1000 may include a processor 1060 such as, for example, a central processing unit (CPU), a graphics processing unit (GPU), or both, a main memory 1070 and a static memory 1080, all of which communicate with each other via a bus 1008. The machine 1000 may further include a video display unit 1010 such as, for example, a liquid crystal display (LCD) or cathode ray tube (CRT) display. The machine 1000 also may include an alphanumeric input device 1020 such as, for example, a keyboard, a cursor control device 1030 such as a mouse, a disk drive unit 1040, a signal generation device 1050 such as a speaker, and a network interface device 470.

The disk drive unit 1040 may include a machine-readable medium 1022 on which is stored one or more sets of instructions 1024 such as, for example, software embodying any one or more of the methodologies or functions described herein. The instructions 1024 may also reside, completely or at least partially, within the main memory 1070 and/or within the processor 1060 during execution thereof by the machine 1000. Preferably, the main memory 1070 and the processor 1060 also comprise machine-readable media. The instructions 1024 may further be transmitted or received over a network 1075 via the network interface device 470. The network 1075 may operate as the network 130 of FIG. 1 and/or the WAN 750 of FIG. 7.

While the machine-readable medium 1022 is shown in an example embodiment to be a single medium, the term “machine-readable medium” should be taken to include a single medium or multiple media such as, for example, media found in a centralized or distributed database, and/or associated caches and servers that store the one or more sets of instructions. The term “machine-readable medium” shall also be taken to include any medium that is capable of storing, encoding, and/or carrying a set of instructions for execution by the apparatus and that cause the apparatus to perform any one or more of the methodologies of the present technology. The term “machine-readable medium” shall accordingly be taken to include, but not be limited to, solid-state memories and optical and magnetic media.

Embodiments of a dynamically configurable cluster of apparatuses and methods for dynamically configuring the apparatuses have been described. Although the present embodiments have been described, it will be evident that various modifications and changes may be made to these embodiments. Accordingly, the specification and drawings are to be regarded in an illustrative rather than a restrictive sense.

The Abstract of the Disclosure is provided to comply with 37 C.F.R. §1.72(b), requiring an abstract that allows the reader to quickly ascertain the nature of the technical disclosure. It is submitted with the understanding that it will not be used to interpret or limit the claims. In addition, in the foregoing Detailed Description, it may be seen that various features are grouped together in a single embodiment for the purpose of streamlining the disclosure. This method of disclosure is not to be interpreted as limiting the claims. Thus, the following claims are hereby incorporated into the Detailed Description, with each claim standing on its own as a separate embodiment.

What is claimed is:

1. A computerized method comprising:
at a server computer,
receiving from an apparatus of a plurality of apparatuses, via a network, a list of identified resources available to the plurality of apparatuses;
providing to the apparatus of the plurality of apparatuses a list of functionalities including functionalities performable by at least some of the plurality of apparatuses, based on the list of identified resources;
receiving from the apparatus of the plurality of apparatuses a selection from the list of functionalities; and
providing one or more of the apparatuses of the plurality of apparatuses with additional resources based on the selection.

2. The method of claim 1, wherein the apparatus comprises one of the plurality of apparatuses from which a first communication is received at the server.

3. The method of claim 1, further comprising facilitating for at least some of the apparatuses of the plurality of apparatuses to form a local cluster, including at least one of a home cluster, a car cluster, or a vacation home cluster.

4. The method of claim 1, wherein the facilitating comprises providing a computer program to be received by the apparatuses of the plurality of apparatuses, and wherein the plurality of apparatuses of the local cluster share at least one of resources or content, among themselves and/or with other local clusters.

5. The method of claim 1, further comprising:
assigning to the apparatus of the plurality of apparatuses a cluster controller role to perform at least one task; and
assigning the cluster controller role to another apparatus of the plurality of apparatuses, when a current cluster controller is not available.

6. The method of claim 5, further comprising receiving a request from the other apparatus to act as a cluster controller, when the other apparatus fails to detect the current cluster controller.

7. The method of claim 5, further comprising monitoring qualifications of the plurality of apparatuses and reassigning the cluster controller role to another apparatus of the plurality of apparatuses, when the other apparatus of the plurality of apparatuses is more qualified than a current cluster controller.

8. The method of claim 7, wherein the more qualified apparatus has at least one of a longer uptime, more resources, or better performance.

9. The method of claim 1, further comprising:
setting up a server database to store at least one of the list of identified recourses, the list of functionalities, or current configurations of the plurality of apparatuses; and
dynamically updating a server database.

10. The method of claim 1, further comprising permitting at least one apparatus of the plurality of apparatuses to act as a proxy for the server computer.

11. The method of claim 10, further comprising facilitating for the at least one apparatus to perform at least some functionalities associated with the server computer.

12. The method of claim 1, facilitating for two or more local clusters to share at least one of a resource or content.

13. The method of claim 1, wherein the resources comprise at least one of software, hardware, an interface, a database or a resource associated with an external device connected to at least one of the plurality of apparatuses, and wherein the additional resources include at least one of software or a database, the database including at least one of libraries, configuration files, images or fonts.

14. The method of claim 1, further comprising receiving a selected functionality for at least one of the plurality of apparatuses from a user and providing a list of one or more external devices to be connected to the at least one apparatus to enable the at least one apparatus to perform the selected functionality.

15. The method of claim 1, wherein the functionalities comprise at least one of functionalities associated with one or more consumer electronic apparatuses or functionalities associated with one or more scientific/research instruments.

16. A system comprising:
a server computer including:
a communication module to receive, via a network, from an apparatus of a plurality of apparatuses, a list of identified resources available to the plurality of apparatuses;
a provisioning module to provide to the apparatus of the plurality of apparatuses a list of functionalities including functionalities performable by at least some apparatuses of the plurality of apparatuses, based on the list of identified resources;
the communication module to receive from the apparatus of the plurality of apparatuses a selection from the list of functionalities; and
the provisioning module to provide one or more of the apparatuses of the plurality of apparatuses with additional resources based on the selection.

17. The system of claim 16, wherein the provisioning module is to facilitate for at least some of the apparatuses of the plurality of apparatuses to form a local cluster, including at least one of a home cluster, a car cluster, or a vacation home cluster.

18. The system of claim 16, further comprising a cluster control module to assign to the apparatus of the plurality of apparatuses a cluster controller role to perform at least one task, and, wherein the cluster control module is to reassign the cluster controller role to another apparatus of the plurality of apparatuses, when a current cluster controller is not available.

19. The system of claim 18, wherein the communication module is to receive a request from the other apparatus to act as a cluster controller, when the other apparatus fails to detect the cluster controller, and wherein the cluster control module is to monitor qualifications of the plurality of apparatuses and to assign the cluster controller role to another apparatus of the plurality of apparatuses, when the other apparatus of the plurality of apparatuses is more qualified than a current cluster controller.

20. The system of claim 16, further comprising:
memory to retain a server database to store at least one of the list of identified recourses, the list of functionalities, or current configurations of the plurality of apparatuses; and
a processor to dynamically update a server database.

21. The system of claim 16, further comprising a proxy module to permit an apparatus of the plurality of apparatuses to act as a proxy for the server computer, and wherein the proxy module is to facilitate for the apparatus to perform at least some functionalities associated with the server computer.

22. The system of claim 16, wherein the provisioning module is to facilitate for two or more local clusters to share at least one of a resource or content.

23. The system of claim 16, wherein the communication module is to receive a selected functionality for an apparatus of the plurality of apparatuses from a user and the provisioning module is to provide a list of one or more external devices to be connected to the apparatus to enable the apparatus to perform the selected functionality.

24. A computer-readable medium comprising instructions which, when executed by one or more processors, perform a method comprising:
receiving from an apparatus of a plurality of apparatuses, via a network, a list of identified resources available to the plurality of apparatuses;
providing to the apparatus of the plurality of apparatuses a list of functionalities including functionalities performable by at least some apparatuses of the plurality of apparatuses, based on the list of identified resources;
receiving from the apparatus of the plurality of apparatuses a selection from the list of functionalities; and
providing one or more of the apparatuses of the plurality of apparatuses with additional resources based on the selection.

25. A system comprising:
a local cluster including a plurality of apparatuses forming a local area network (LAN), the LAN to be coupled via a wide area network (WAN) to a server computer;
at least some of the apparatuses of the plurality of apparatuses to comprise,
an identification module to dynamically identify a list of resources available to the at least some of the apparatuses;
a network interface device to communicate to the server computer the list of resources;
the network interface device to receive from the server computer a list of functionalities performable by the at least some of the apparatuses, based on the list of resources;
a user interface device to receive a selection from the list of functionalities;
the network interface device to receive from the server computer additional resources based on the selection; and
a configuration module to configure the at least some of the apparatuses to perform selected functionalities by using the additional resources.

26. The system of claim 25, wherein the network device apparatus is to transmit to the server computer a request from an apparatus of the plurality of apparatuses to act as a cluster controller, when the apparatus fails to detect the cluster controller.

27. The system of claim 25, wherein the network interface device is to transmit to the server computer a request from an apparatus of the plurality of apparatuses to act as proxy for the server computer.

28. A method comprising:
forming a local cluster including a plurality of apparatuses linked through a local area network (LAN), the LAN to be coupled via a wide area network (WAN) to a server computer;
performing by at least some of the apparatuses of the plurality of apparatuses following acts:
dynamically identifying a list of resources available to the at least some of the apparatuses;
communicating to the server computer the list of resources;
receiving from the server computer a list of functionalities performable by the at least some of the apparatuses, based on the list of resources;
receiving a selection from the list of functionalities;
receiving from the server computer additional resources based on the selection; and
configuring the at least some of the apparatuses to perform selected functionalities by using the additional resources.

29. The method of claim 28, further comprising transmitting to the server computer a request from an apparatus of the plurality of apparatuses to act as a cluster controller, when the apparatus fails to detect the cluster controller.

30. The method of claim 28, further comprising transmitting to the server computer a request from an apparatus of the plurality of apparatuses to act as proxy for the server computer.
